(19) United States
(12) Patent Application Publication
(10) Pub. No.: US 2014/0240467 A1
(43) Pub. Date: Aug. 28, 2014

(54) IMAGE PROCESSING METHOD AND APPARATUS FOR ELIMINATION OF DEPTH ARTIFACTS

(71) Applicant: LSI Corporation, San Jose, CA (US)

(72) Inventors: Alexander A. Petyushko, Moscow (RU); Alexander B. Kholodenko, Moscow (RU); Ivan L. Mazurenko, Moscow (RU); Denis V. Parfenov, Moscow (RU); Dmitry N. Babin, Moscow (RU)

(73) Assignee: LSI Corporation, San Jose, CA (US)

(21) Appl. No.: 14/232,143

(22) PCT Filed: May 17, 2013
(86) PCT No.: PCT/US13/41507

§ 371 Date: Jan. 10, 2014

(30) Foreign Application Priority Data
Oct. 24, 2012 (RU) 2012145349

(51) Int. Cl. H04N 5/232; H04N 13/02

(52) U.S. Cl. CPC H04N 5/232; H04N 13/0239; H04N 2013/0081
USPC 348/47

(57) ABSTRACT

An image processing system comprises an image processor configured to identify one or more potentially defective pixels associated with at least one depth artifact in a first image, and to apply a super resolution technique utilizing a second image to reconstruct depth information of the one or more potentially defective pixels. Application of the super resolution technique produces a third image having the reconstructed depth information. The first image may comprise a depth image and the third image may comprise a depth image corresponding generally to the first image but with the depth artifact substantially eliminated. An additional super resolution technique may be applied utilizing a fourth image. Application of the additional super resolution technique produces a fifth image having increased spatial resolution relative to the third image.

### Background

A number of different techniques are known for generating three-dimensional (3D) images of a spatial scene in real time. For example, 3D images of a spatial scene may be generated using triangulation based on multiple two-dimensional (2D) images. However, a significant drawback of such a technique is that it generally requires very intensive computations, and can therefore consume an excessive amount of the available computational resources of a computer or other processing device.

Other known techniques include directly generating a 3D image using a 3D imager such as a structured light (SL) camera or a time of flight (ToF) camera. Cameras of this type are usually compact, provide rapid image generation, and emit low amounts of power, and operate in the near-infrared part of the electromagnetic spectrum in order to avoid interference with human vision. As a result, SL and ToF cameras are commonly used in image processing system applications such as gesture recognition in video gaming systems or other systems requiring a gesture-based human-machine interface.

Unfortunately, the 3D images generated by SL and ToF cameras typically have very limited spatial resolution. For example, SL cameras have inherent difficulties with precision in an x-y plane because they implement light pattern-based triangulation in which pattern size cannot be made arbitrarily fine-granulated to achieve high resolution. Also, in order to avoid eye injury, both overall emitted power across the entire pattern as well as spatial and angular power density in each pattern element (e.g., a line or a spot) are limited. The resulting image therefore exhibits low signal-to-noise ratio and provides only a limited quality depth map, potentially including numerous depth artifacts.

Although ToF cameras are able to determine x-y coordinates more precisely than SL cameras, ToF cameras also have issues with regard to spatial resolution. For example, depth measurements in the form of z coordinates are typically generated in a ToF camera using techniques requiring very fast switching and temporal integration in analog circuitry, which can limit the achievable quality of the depth map, again leading to an image that may include a significant number of depth artifacts.

### SUMMARY

Embodiments of the invention provide image processing systems that process depth maps or other types of depth images in a manner that allows depth artifacts to be substantially eliminated or otherwise reduced in a particularly efficient manner. One or more of these embodiments involve applying a super resolution technique that utilizes at least one 2D image of substantially the same scene, but possibly from another image source, in order to reconstruct depth information associated with one or more depth artifacts in a depth image generated by a 3D imager such as an SL camera or a ToF camera.

In one embodiment, an image processing system comprises an image processor configured to identify one or more potentially defective pixels associated with at least one depth artifact in a first image, and to apply a super resolution technique utilizing a second image to reconstruct depth information of the one or more potentially defective pixels. Application of the super resolution technique produces a third image having the reconstructed depth information. The first image may comprise a depth image and the third image may comprise a depth image corresponding generally to the first image but with the depth artifact substantially eliminated. The first, second and third images may all have substantially the same spatial resolution. An additional super resolution technique may be applied utilizing a fourth image having a spatial resolution that is greater than that of the first, second and third images. Application of the additional super resolution technique produces a fifth image having increased spatial resolution relative to the third image.

Embodiments of the invention can effectively remove distortion and other types of depth artifacts from depth images generated by SL and ToF cameras and other types of real-time 3D imagers. For example, potentially defective pixels associated with depth artifacts can be identified and removed, and the corresponding depth information reconstructed using a first super resolution technique, followed by spatial resolution enhancement of the resulting depth image using a second super resolution technique.

### BRIEF DESCRIPTION OF THE DRAWINGS

FIG. 1 is a block diagram of an image processing system in one embodiment.

FIG. 2 is a flow diagram of a process for elimination of depth artifacts in one embodiment.

FIG. 3 illustrates a portion of an exemplary depth image that includes a depth artifact comprising an area of multiple contiguous potentially defective pixels.

FIG. 4 shows a pixel neighborhood around a given isolated potentially defective pixel in an exemplary depth image.

FIG. 5 is a flow diagram of a process for elimination of depth artifacts in another embodiment.

### DETAILED DESCRIPTION

Embodiments of the invention will be illustrated herein in conjunction with exemplary image processing systems that include image processors or other types of processing devices and implement super resolution techniques for processing depth maps or other depth images to detect and substantially eliminate or otherwise reduce depth artifacts. It should be understood, however, that embodiments of the invention are more generally applicable to any image processing system or associated device or technique in which it is desirable to substantially eliminate or otherwise reduce depth artifacts.

FIG. 1 shows an image processing system 100 in an embodiment of the invention. The image processing system 100 comprises an image processor 102 that receives images from image sources 104 and provides processed images to image destinations 106.

The image sources 104 comprise, for example, 3D imagers such as SL and ToF cameras as well as one or more 2D imagers such as 2D imagers configured to generate 2D infrared images, gray scale images, color images or other types of 2D images, in any combination. Another example of one of the image sources 104 is a storage device or server that provides images to the image processor 102 for processing.

The image destinations 106 illustratively comprise, for example, one or more display screens of a human-machine interface, or at least one storage device or server that receives processed images from the image processor 102.

Although shown as being separate from the image sources 104 and image destinations 106 in the present embodiment, the image processor 102 may be at least partially combined with one or more image sources or image destinations on a common processing device. Thus, for example, one or more of the image sources 104 and the image processor 102 may be collectively implemented on the same processing device. Similarly, one or more of the image destinations 106 and the image processor 102 may be collectively implemented on the same processing device.

In one embodiment the image processing system 100 is implemented as a video gaming system or other type of gesture-based system that processes images in order to recognize user gestures. The disclosed techniques can be similarly adapted for use in a wide variety of other systems requiring a gesture-based human-machine interface, and can also be applied to applications other than gesture recognition, such as machine vision systems in robotics and other industrial applications.

The image processor 102 in the present embodiment is implemented using at least one processing device and comprises a processor 110 coupled to a memory 112. Also included in the image processor 102 are a pixel identification module 114 and a super resolution module 116. The pixel identification module 114 is configured to identify one or more potentially defective pixels associated with at least one depth artifact in a first image received from one of the image sources 104. The super resolution module 116 is configured to utilize a second image received from possibly a different one of the image sources 104 in order to reconstruct depth information of the one or more potentially defective pixels, so as to thereby produce a third image having the reconstructed depth information.

In the present embodiment, it is assumed without limitation that the first image comprises a depth image of a first resolution from a first one of the image sources 104 and the second image comprises a 2D image of substantially the same scene and having a resolution substantially the same as the first resolution from another one of the image sources 104 different than the first image source. For example, the first image source may comprise a 3D image source such as a structured light or ToF camera, and the second image source may comprise a 2D image source configured to generate the second image as an infrared image, a gray scale image or a color image. As indicated above, in other embodiments the same image source supplies both the first and second images.

The super resolution module 116 may be further configured to process the third image utilizing a fourth image in order to produce a fifth image having increased spatial resolution relative to the third image. In such an arrangement, the first image illustratively comprises a depth image of a first resolution from a first one of the image sources 104 and the fourth image comprises a 2D image of substantially the same scene and having a resolution substantially greater than the first resolution from another one of the image sources 104 different than the first image source.

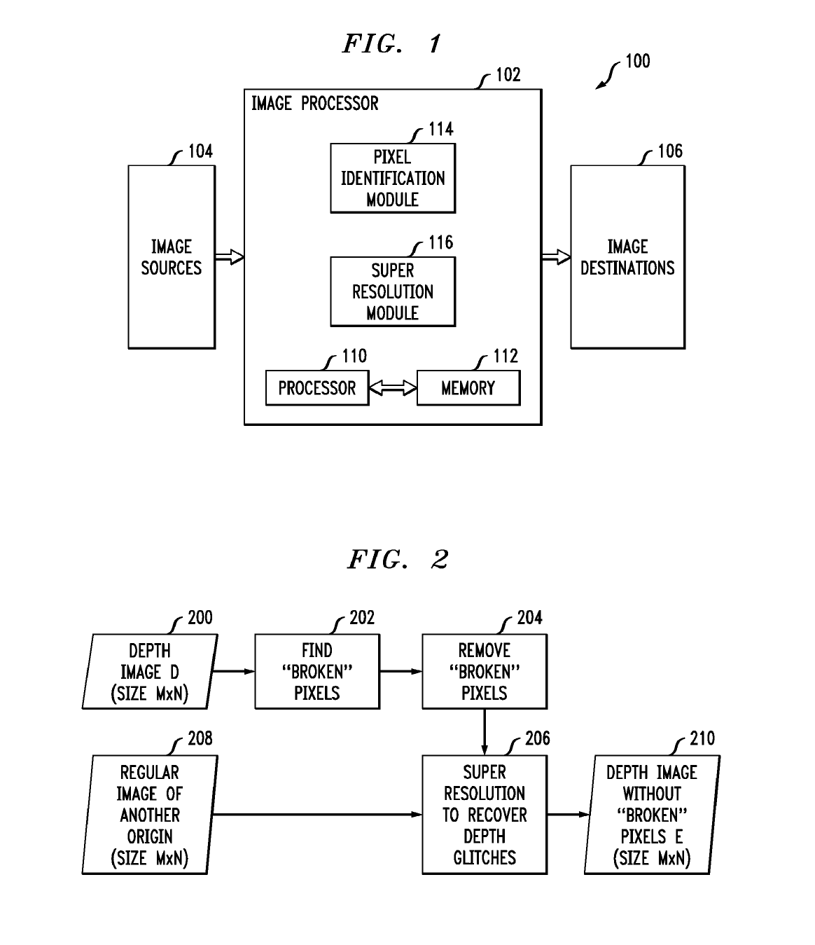

Exemplary image processing operations implemented using pixel identification module 114 and super resolution module 116 of image processor 102 will be described in greater detail below in conjunction with FIGS. 2 through 5.

The processor 110 and memory 112 in the FIG. 1 embodiment may comprise respective portions of at least one processing device comprising a microprocessor, an application-specific integrated circuit (ASIC), a field-programmable gate array (FPGA), a central processing unit (CPU), an arithmetic logic unit (ALU), a digital signal processor (DSP), or other similar processing device component, as well as other types and arrangements of image processing circuitry, in any combination.

The pixel identification module 114 and the super resolution module 116 or portions thereof may be implemented at least in part in the form of software that is stored in memory 112 and executed by processor 110. A given such memory that stores software code for execution by a corresponding processor is an example of what is more generally referred to herein as a computer-readable medium or other type of computer program product having computer program code embodied therein, and may comprise, for example, electronic memory such as random access memory (RAM) or read-only memory (ROM), magnetic memory, optical memory, or other types of storage devices in any combination. As indicated above, the processor may comprise portions or combinations of a microprocessor, ASIC, FPGA, CPU, ALU, DSP or other image processing circuitry.

It should also be appreciated that embodiments of the invention may be implemented in the form of integrated circuits. In a given such integrated circuit implementation, identical die are typically formed in a repeated pattern on a surface of a semiconductor wafer. Each die includes image processing circuitry as described herein, and may include other structures or circuits. The individual die are cut or diced from the wafer, then packaged as an integrated circuit. One skilled in the art would know how to dice wafers and package die to produce integrated circuits. Integrated circuits so manufactured are considered embodiments of the invention.

The particular configuration of image processing system 100 as shown in FIG. 1 is exemplary only, and the system 100 in other embodiments may include other elements in addition to or in place of those specifically shown, including one or more elements of a type commonly found in a conventional implementation of such a system.

Referring now to the flow diagram of FIG. 2, a process is shown for elimination of depth artifacts in a depth image generated by a 3D imager in one embodiment. The process is assumed to be implemented by the image processor 102 using its pixel identification module 114 and super resolution module 116. The process in this embodiment begins with a first image 200 that illustratively comprises a depth image D having a spatial resolution or size in pixels of M×N. Such an image is assumed to be provided by a 3D imager such as an SL camera or a ToF camera and will therefore typically include one or more depth artifacts. For example, depth artifacts may include “shadows” that often arise when using an SL camera or other 3D imager.

In step 202, one or more potentially defective pixels associated with at least one depth artifact in the depth image D arc identified. These potentially defective pixels are more specifically referred to in the context of the present embodiment and other embodiments herein as “broken” pixels, and should be generally understood to include any pixels that are determined with a sufficiently high probability to be associated with one or more depth artifacts in the depth image D. Any pixels that are so identified may be marked or otherwise indicated as broken pixels in step 202, so as to facilitate removal or other subsequent processing of these pixels. Alternatively, only a subset of the broken pixels may be marked for removal or other subsequent processing based on thresholding or other criteria.

In step 204, the “broken” pixels identified in step 202 are removed from the depth image D. It should be noted that in other embodiments, the broken pixels need not be entirely removed. Instead, only a subset of these pixels could be removed, based on thresholding or other specified pixel removal criteria, or certain additional processing operations could be applied to at least a subset of these pixels so as to facilitate subsequent reconstruction of the depth information. Accordingly, explicit removal of all pixels identified as potentially defective in step 202 is not required.

In step 206, a super resolution technique is applied to the modified depth image D using a second image 208 illustratively referred to in this embodiment as a regular image from another origin. Thus, for example, the second image 208 may be an image of substantially the same scene but provided by a different one of the image sources 104, such as a 2D imager, and will therefore generally not include depth artifacts of the type found in the depth image D. The second image 208 in this embodiment is assumed to have the same resolution as the depth image D, and is therefore an M×N image, but comprises a regular image as contrasted to a depth image. However, in other embodiments, the second image 208 may have a higher resolution than the depth image D. Examples of regular images that may be used in this embodiment and other embodiments described herein include infrared images, gray scale images or color images generated by a 2D imager.

Accordingly, step 206 in the present embodiment generally utilizes two different types of images, a depth image with broken pixels removed and a regular image, both having substantially the same size.

Application of the super resolution technique in step 206 utilizing regular image 208 serves to reconstruct depth information of the broken pixels removed from the image in step 204, producing a third image 210. For example, depth information for the broken pixels removed in step 204 may be reconstructed by combining depth information from neighboring pixels in the depth map D with intensity data from an infrared, gray scale or color image corresponding to the second image 208.

This operation may be viewed as recovering from depth glitches or other depth artifacts associated with the removed pixels, without increasing the spatial resolution of the depth image D. The third image 210 in this embodiment comprises a depth image E of resolution M×N that does not include the broken pixels but instead includes the reconstructed depth information. The super resolution technique of step 206 should be capable of dealing with non-regular sets of depth points, as the corresponding pixel grid includes gaps where broken pixels at random positions were removed in step 204.

As will be described in more detail below, the super resolution technique applied in step 206 may be based at least in part, for example, on a Markov random field model. It is to be appreciated, however, that numerous other super resolution techniques suitable for reconstructing depth information associated with removed pixels may be used.

Also, the steps 202, 204 and 206 may be iterated in order to locate and substantially eliminate additional depth artifacts.

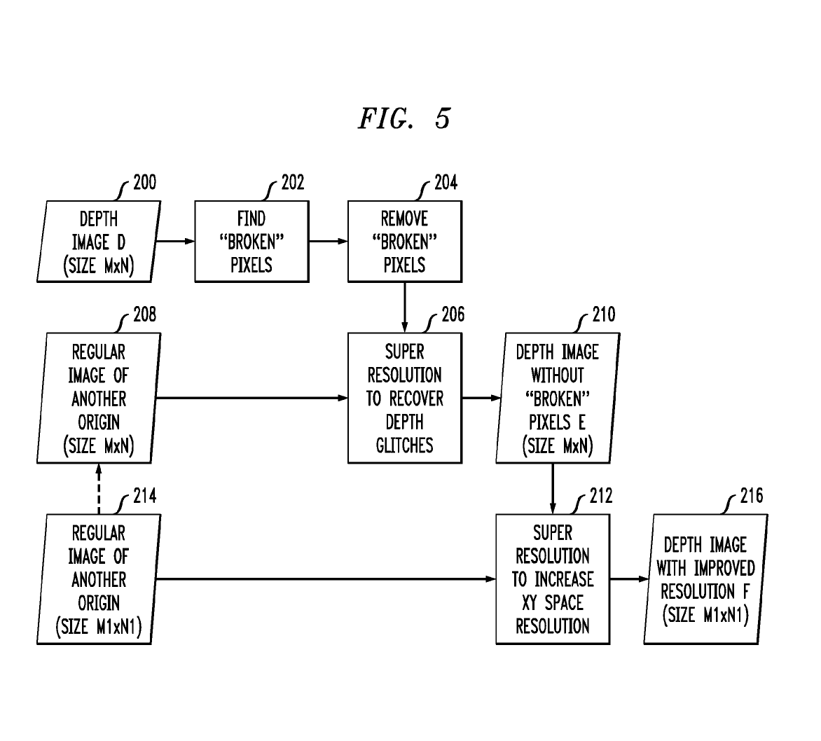

In the FIG. 2 embodiment, the first image 200, second image 208 and third image 210 all have the same spatial resolution or size in pixels, namely, a resolution of M×N pixels. The first and third images are depth images, and the second image is a regular image. More particularly, the third image is a depth image corresponding generally to the first image but with the one or more depth artifacts substantially eliminated. Again, the first, second and third images all have substantially the same spatial resolution. In another embodiment to be described below in conjunction with FIG. 5, spatial resolution of the third image 210 is increased using another super resolution technique, which is generally a different technique than that applied to reconstruct the depth information in step 206.

The depth image E generated by the FIG. 2 process is typically characterized by better visual and instrumental quality, sharper edges of more regular and natural shape, lower noise impact, and absence of depth outliers, speckles, saturated spots from highly-reflective surfaces or other depth artifacts, relative to the original depth image D.

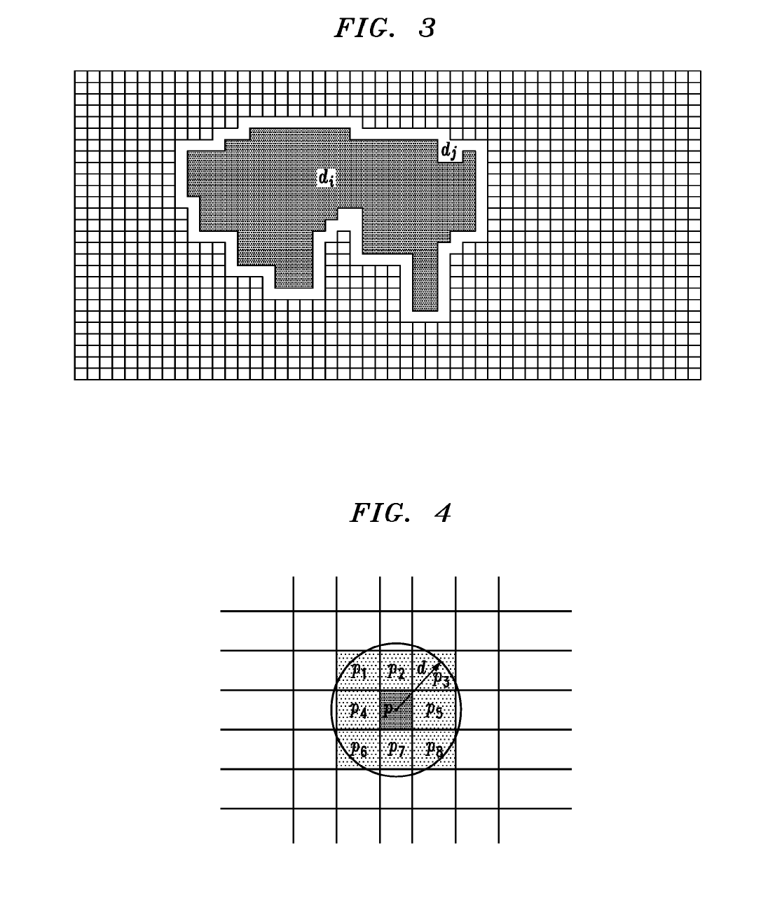

Exemplary techniques for identifying potentially defective pixels in the depth image D in step 202 of the FIG. 2 process will now be described in greater detail with reference to FIGS. 3 and 4. It should initially be noted that such pixels may be identified in some embodiments as any pixels that have depth values set to respective predetermined error values by an associated 3D imager, such as an SL camera or a ToF camera. For example, such cameras may be configured to use a depth value of z=0 as a predetermined error value to indicate that a corresponding pixel is potentially defective in terms of its depth information. In embodiments of this type, any pixels having the predetermined error values may be identified as broken pixels in step 202.

Other techniques for identifying potentially defective pixels in the depth image D include detecting areas of contiguous potentially defective pixels, as illustrated in FIG. 3, and detecting particular potentially defective pixels, as illustrated in FIG. 4.

Referring now to FIG. 3, a portion of depth image D is shown as including a depth artifact comprising a shaded area of multiple contiguous potentially defective pixels. Each of the contiguous potentially defective pixels in the shaded area may comprise contiguous pixels having respective unexpected depth values that differ substantially from depth values of pixels outside of the shaded area. For example, the shaded area in this embodiment is surrounded by an unshaded peripheral border, and the shaded area may be defined so as to satisfy the following inequality with reference to the peripheral border:

|mean{dᵢ: pixel i is in the area}−mean{dⱼ: pixel j is in the border}|>d_{T}

where d_{T} is a threshold value. If such unexpected depth areas are detected, all pixels inside each of the detected areas are marked as broken pixels. Numerous other techniques may be used to identify an area of contiguous potentially defective pixels corresponding to a given depth artifact in other embodiments. For example, the above-noted inequality can be more generally expressed to utilize a statistic as follows:

|statistic{dᵢ: pixel i is in the area}−statistic{dⱼ: pixel j is in the border}|>d_{T}

where statistic can be a mean as given previously, or any of a wide variety of other types of statistics, such as a median, or a p-norm distance metric. In the case of a p-norm distance metric, the statistic in the above inequality may be expressed as follows:

$$statistic = {( {\sum }_{i = 1}^{I} sign ( {x}_{i} ) {\vert {x}_{i} \vert}^{p} )}^{1 / p}$$

where xᵢ in this example more particularly denotes an element of a vector x associated with a given pixel, and where p≧1.

FIG. 4 shows a pixel neighborhood around a given isolated potentially defective pixel in the depth image D. In this embodiment, the pixel neighborhood comprises eight pixels p₁ through p₈ surrounding a particular pixel p. The particular pixel p in this embodiment is identified as a potentially defective pixel based on a depth value of the particular pixel and at least one of a mean and a standard deviation of depth values of the respective pixels in the neighborhood of pixels.

By way of example, the neighborhood of pixels for the particular pixel p illustratively comprises a set Sₚ of n neighbors of pixel p:

Sₚ{p₁, . . . , pₙ},

where the n neighbors each satisfy the inequality:

∥p−pᵢ∥<d,

where d is a threshold or neighborhood radius and ∥·∥ denotes Euclidian distance between pixels p and pᵢ in the x-y plane, as measured between their respective centers. Although Euclidean distance is used in this example, other types of distance metrics may be used, such as a Manhattan distance metric, or more generally a p-norm distance metric of the type described previously. An example of d corresponding to a radius of a circle is illustrated in FIG. 4 for the eight-pixel neighborhood of pixel p. It should be understood, however, that numerous other techniques may be used to identify pixel neighborhoods for respective particular pixels.

Again by way of example, a given particular pixel p can be identified as a potentially defective pixel and marked as broken if the following inequality is satisfied:

|zₚ−m|>kσ,

where zₚ is the depth value of the particular pixel, m and σ are the mean and standard deviation, respectively, of the depth values of the respective pixels in the neighborhood of pixels, and k is a multiplying factor specifying a degree of confidence. As one example, the confidence factor in some embodiments is given by k=3. A variety of other distance metrics may be used in other embodiments.

The mean m and standard deviation σ in the foregoing example may be determined using the following equations:

$$m = \frac{{\sum }_{i = 1}^{n} {z}_{i}}{n}$$

$$σ = \sqrt{\frac{{\sum }_{i = 1}^{n} {( {z}_{i} - m )}^{2}}{n}}$$

It is to be appreciated, however, that other definitions of σ may be used in other embodiments.

Individual potentially defective pixels identified in the manner described above may correspond, for example, to depth artifacts comprising speckle-like noise attributable to physical limitations of the 3D imager used to generate depth map D.

Although the thresholding approach for identifying individual potentially defective pixels may occasionally mark and remove pixels from a border of an object, this is not problematic as the super resolution technique applied in step 206 can reconstruct the depth values of any such removed pixels.

Also, multiple instances of the above-described techniques for identifying potentially defective pixels can be implemented serially in step 202, possibly with one or more additional filters, in a pipelined implementation.

As noted above, the FIG. 2 process can be supplemented with application of an additional, potentially distinct super resolution technique applied to the depth image E in order to substantially increase its spatial resolution. An embodiment of this type is illustrated in the flow diagram of FIG. 5. The process shown includes steps 202, 204 and 206 which utilize a first image 200 and a second image 208 to generate a third image 210, in substantially the same manner as previously described in conjunction with FIG. 2. The process further includes an additional step 212 in which an additional super resolution technique is applied utilizing a fourth image 214 having a spatial resolution that is greater than that of the first, second and third images.

The super resolution technique applied in step 212 in the present embodiment is generally a different technique than that applied in step 206. For example, as indicated above, the super resolution technique applied in step 206 may comprise a Markov random field based super resolution technique or another super resolution technique particularly well suited for reconstruction of depth information. Additional details regarding an exemplary Markov random filed based super resolution technique that may be adapted for use in an embodiment of the invention can be found in, for example, J. Diebel et al., “An Application of Markov Random Fields to Range Sensing,” NIPS, MIT Press, pp. 291-298, 2005, which is incorporated by reference herein. In contrast, the super resolution technique applied in step 212 may comprise a super resolution technique particularly well suited for increasing spatial resolution of a low resolution image using a higher resolution image, such as a super resolution technique based at least in part on bilateral filters. An example of a super resolution technique of this type is described in Q. Yang et al., “Spatial-Depth Super Resolution for Range Images,” IEEE Conference on Computer Vision and Pattern Recognition (CVPR), 2007, which is incorporated by reference herein.

The above are just examples of super resolution techniques that may be used in embodiments of the invention. The term “super resolution technique” as used herein is intended to be broadly construed so as to encompass techniques that can be used to enhance the resolution of a given image, possibly by using one or more other images.

Application of the additional super resolution technique in step 212 produces a fifth image 216 having increased spatial resolution relative to the third image. The fourth image 214 is a regular image having a spatial resolution or size in pixels of M1×N1 pixels, where it is assumed that M1>M and N1>N. The fifth image 216 is a depth image generally corresponding to the first image 200 but with one or more depth artifacts substantially eliminated and the spatial resolution increased.

Like the third image 208, the fourth image 214 is a 2D image of substantially the same scene as the first image 200, illustratively provided by a different imager than the 3D imager used to generate the first image. For example, the fourth image 214 may be an infrared image, a gray scale image or a color image generated by a 2D imager.

As noted above, different super resolution techniques are generally used in steps 206 and 212. For example, a super resolution technique used in step 206 to reconstruct depth information for removed broken pixels may not provide sufficiently precise results in the x-y plane. Accordingly, the super resolution technique applied in step 212 may be optimized for correcting lateral spatial errors. Examples include super resolution techniques based on bilateral filters, as mentioned previously, or super resolution techniques that are configured so as to be more sensitive to edges, contours, borders and other features in the regular image 214 than it is to features in the depth image E. Depth errors are not particularly important at this step of the FIG. 5 process because those depth errors are substantially corrected by the super resolution technique applied in step 206.

The dashed arrow from the M1×N1 regular image 214 to the M×N regular image 208 in FIG. 5 indicates that the latter image may be generated from the former image using downsampling or other similar operation.

In the FIG. 5 embodiment, potentially defective pixels associated with depth artifacts are identified and removed, and the corresponding depth information reconstructed using a first super resolution technique in step 206, followed by spatial resolution enhancement of the resulting depth image using a second super resolution technique in step 212, where the second super resolution technique is generally different than the first super resolution technique.

It should also be noted that the FIG. 5 embodiment provides a significant stability advantage over conventional arrangements that involve application of a single super resolution technique without removal of depth artifacts. In the FIG. 5 embodiment, the first super resolution technique achieves a low resolution depth map that is substantially without depth artifacts, so as to thereby enhance the performance of the second super resolution technique in improving spatial resolution.

The embodiment of FIG. 2 using only the first super resolution technique in step 206 may be used in applications in which only elimination of depth artifacts in a depth map is required, or if there is insufficient processing power or time available to improve the spatial resolution of the depth map using the second super resolution technique in step 212 of the FIG. 5 embodiment. However, the use of the FIG. 2 embodiment as a pre-processing stage of the image processor 102 can provide significant quality improvement in the output images resulting from any subsequent resolution enhancement process.

In these and other embodiments, distortion and other types of depth artifacts are effectively removed from depth images generated by SL and ToF cameras and other types of real-time 3D imagers.

It should again be emphasized that the embodiments of the invention as described herein are intended to be illustrative only. For example, other embodiments of the invention can be implemented utilizing a wide variety of different types and arrangements of image processing circuitry, pixel identification techniques, super resolution techniques and other processing operations than those utilized in the particular embodiments described herein. In addition, the particular assumptions made herein in the context of describing certain embodiments need not apply in other embodiments. These and numerous other alternative embodiments within the scope of the following claims will be readily apparent to those skilled in the art.

What is claimed is:

1. A method comprising:
identifying one or more potentially defective pixels associated with at least one depth artifact in a first image; and
applying a super resolution technique utilizing a second image to reconstruct depth information of said one or more potentially defective pixels;
wherein application of the super resolution technique produces a third image having the reconstructed depth information;
wherein the identifying and applying steps are implemented in at least one processing device comprising a processor coupled to a memory.

2. The method of claim 1 wherein the first image comprises a depth image and the third image comprises a depth image corresponding generally to the first image but with said at least one depth artifact substantially eliminated.

3. The method of claim 1 further comprising:
applying an additional super resolution technique utilizing a fourth image;
wherein application of the additional super resolution technique produces a fifth image having increased spatial resolution relative to the third image.

4. The method of claim 3 wherein the first image comprises a depth image and the fifth image comprises a depth image generally corresponding to the first image but with said at least one depth artifact substantially eliminated and the resolution increased.

5. The method of claim 1 wherein identifying one or more potentially defective pixels comprises:
marking at least a subset of the potentially defective pixels; and
removing the marked potentially defective pixels from the first image prior to applying the super resolution technique.

6. The method of claim 1 wherein the first image comprises a depth image of a first resolution from a first image source and the second image comprises a two-dimensional image of substantially the same scene and having a resolution substantially the same as the first resolution from another image source different than the first image source.

7. The method of claim 3 wherein the first image comprises a depth image of a first resolution from a first image source and the fourth image comprises a two-dimensional image of substantially the same scene and having a resolution substantially greater than the first resolution from another image source different than the first image source,

8. The method of claim 1 wherein identifying one or more potentially defective pixels comprises detecting pixels of the first image having depth values set to respective predetermined error values by an associated depth imager.

9. The method of claim 1 wherein identifying one or more potentially defective pixels comprises detecting an area of contiguous pixels having respective unexpected depth values that differ substantially from depth values of pixels outside of the area.

10. The method of claim 9 wherein the area of contiguous pixels having respective unexpected depth values is defined so as to satisfy the following inequality with reference to a peripheral border of the area:

|statistic{dᵢ: pixel i is in the area}−statistic{dⱼ: pixel j is in the border}|>d_{T}
where d_{T} is a threshold value, and statistic denotes one of mean, median and distance metric.

11. The method of claim 1 wherein identifying one or more potentially defective pixels comprises:
identifying a particular one of the pixels;
identifying a neighborhood of pixels for the particular pixel; and
identifying the particular pixel as a potentially defective pixel based on a depth value of the particular pixel and at least one of a mean and a standard deviation of depth values of the respective pixels in the neighborhood of pixels.

12. The method of claim 11 wherein identifying a neighborhood of pixels for the particular pixel comprises identifying a set Sₚ of n neighbors of particular pixel p:
Sₚ{p₁, . . . , pₙ},
where the n neighbors each satisfy the inequality:
∥p−pᵢ∥<d,
where d is a neighborhood radius and ∥·∥ denotes a distance metric between pixels p and pᵢ in an x-y plane.

13. The method of claim 11 wherein identifying the particular pixel as a potentially defective pixel comprises identifying the particular pixel as a potentially defective pixel if the following inequality is satisfied:

|zₚ−m|>kσ,
where zₚ is the depth value of the particular pixel, in and r are the mean and standard deviation, respectively, of the depth values of the respective pixels in the neighborhood of pixels, and k is a multiplying factor specifying a degree of confidence.

14. The method of claim 1 wherein applying the super resolution technique comprises applying a super resolution technique that is based at least in part on a Markov random field model.

15. The method of claim 3 wherein applying the additional super resolution technique comprises applying a super resolution technique that is based at least in part on bilateral filters.

16. A computer-readable storage medium having computer program code embodied therein, wherein the computer program code when executed in the processing device causes the processing device to perform the method of claim 1.

17. An apparatus comprising:
at least one processing device comprising a processor coupled to a memory;
wherein said at least one processing device comprises:
a pixel identification module configured to identify one or more potentially defective pixels associated with at least one depth artifact in a first image; and
a super resolution module configured to utilize a second image to reconstruct depth information of said one or more potentially defective pixels;
wherein the super resolution module produces a third image having the reconstructed depth information.

18. The apparatus of claim 17 wherein the super resolution module is further configured to process the third image utilizing a fourth image in order to produce a fifth image having increased spatial resolution relative to the third image.

19. The apparatus of claim 17 wherein the first image comprises a depth image of a first resolution from a first image source and the second image comprises a two-dimensional image of substantially the same scene and having a resolution substantially the same as the first resolution from another image source different than the first image source

20. The apparatus of claim 19 wherein the first image source comprises a three-dimensional image source including one of a structured light camera and a time of flight camera.

21. The apparatus of claim 19 wherein the second image source comprises a two-dimensional image source configured to generate the second image as one of an infrared image, a gray scale image and a color image.

22. The apparatus of claim 18 wherein the first image comprises a depth image of a first resolution from a first image source and the fourth image comprises a two-dimensional image of substantially the same scene and having a resolution substantially greater than the first resolution from another image source different than the first image source.

23. An image processing system comprising the apparatus of claim 17.

24. A gesture detection system comprising the image processing system of claim 23.
